(19) United States
(12) Patent Application Publication
(10) Pub. No.: US 2025/0046025 A1
(43) Pub. Date: Feb. 6, 2025

(54) SMART DIGITAL INTERACTIONS WITH AUGMENTED REALITY AND GENERATIVE ARTIFICIAL INTELLIGENCE

(71) Applicant: Wells Fargo Bank, N.A., San Francisco, CA (US)

(72) Inventors: Daniel Sanford, Charlotte, NC (US); Kris Jain, San Francisco, CA (US); Drew Jahn, San Francisco, CA (US); Albert Hwu, San Francisco, CA (US); Rich Schultz, San Francisco, CA (US); Franco Ramos-Johnson, Orlando, FL (US); Elizabeth C. Kerwood, San Francisco, CA (US); Jason Ehrlich, San Francisco, CA (US); Jennifer Marie Jones, San Francisco, CA (US); Collin Raysor, San Francisco, CA (US)

(21) Appl. No.: 18/793,089

(22) Filed: Aug. 2, 2024

Related U.S. Application Data
(60) Provisional application No. 63/530,662, filed on Aug. 3, 2023.

(51) Int. Cl. G06T 19/00; G06F 21/35

(52) U.S. Cl. CPC G06T 19/006; G06F 21/35

(57) ABSTRACT

Systems, methods, and devices for smart digital interactions with augmented reality and generative artificial intelligence are disclosed. A method includes authenticating a user according to one or more authentication settings provided to the premises computing system. The authentication settings can authorize presentation and processing of a subset of the user data records. The method further includes monitoring user input from the user via an input device of the premises computing system, and transmitting, to a generative artificial intelligence system, a request to generate a response based on the user input. The request is in regard to the subset of the user data records. The method also includes presenting, via an augmented reality device, at least one visualization generated based on the response received from the generative artificial intelligence system.

### CROSS-REFERENCES TO RELATED APPLICATION

This application claims the benefit of and priority to U.S. Provisional Patent Application No. 63/530,662, filed Aug. 3, 2023, which is incorporated herein by reference in its entirety and for all purposes.

### TECHNICAL FIELD

The present disclosure relates to digital interactions with augmented reality and generative artificial intelligence (AI) in a distributed computing environment.

### BACKGROUND

Client applications can access resources from servers. However, accessing user-requested information in real-time is challenging because requests for information must be specifically tailored to formats compatible with the computing systems handling the request.

### SUMMARY

The systems, methods, and apparatuses described herein relate to enabling, generating, and providing digital interactions with augmented reality and generative artificial intelligence models that receive and process requests for information in real-time or nearly real-time, and automatically generate graphical user interfaces in augmented reality computing environments to communicate retrieved information. The computing systems described herein can access or execute generative artificial intelligence models to automatically generate graphical user interfaces that display dynamic data relating to one or more modality inputs (e.g., natural language provided as input). This information can be dynamically updated as additional natural language is monitored to provide up-to-data in real-time.

At least one aspect of the present disclosure is directed to a method. The method may be performed, for example, by a premises computing system at a premises location. The method includes authenticating a user according to one or more authentication settings provided to the premises computing system. The user can be associated with user data records stored by a primary computing system in communication with the premises computing system. The authentication settings can authorize presentation and processing of a subset of the user data records. The method includes monitoring user input from the user via an input device of the premises computing system. The method includes transmitting, to a generative artificial intelligence system, a request to generate a response based on the user input, the request regarding the subset of the user data records. The method includes presenting, via an augmented reality device, at least one visualization generated based on the response received from the generative artificial intelligence system.

In some implementations, the method includes authenticating the user further based on a wireless communication from a mobile device of the user. In some implementations, the user input comprises audio data. In some implementations, the method includes monitoring speech input from the user based on the audio data captured via the input device of the premises computing system. In some implementations, the speech input is processed using a text-to-speech model. In some implementations, the method includes automatically transmitting the request to generate the response responsive to detecting the user input. In some implementations, the method includes receiving the response from the generative artificial intelligence system, the response comprising at least one template. In some implementations, the method includes generating the at least one visualization based on the at least one template of the response.

In some implementations, the method includes authenticating a remote user via a remote computing system. In some implementations, the method includes providing the at least one visualization to the remote computing system responsive to authenticating the remote user. In some implementations, the one or more authentication settings for the user authorize a second subset of the user data to be shared with the remote user. In some implementations, the method includes determining that the at least one visualization is to be shared with the remote computing system based on the one or more authentication settings. In some implementations, the method includes providing the at least one visualization to the remote computing system responsive to determining that the at least one visualization is to be shared with the remote computing system.

In some implementations, the method includes providing, by the premises computing system, a video stream to the remote computing system for display with the at least one visualization. In some implementations, the method includes receiving the response from the generative artificial intelligence system, the response including instructions to retrieve the subset of the user data records from the primary computing system. In some implementations, the method includes generating the at least one visualization by retrieving the subset of the user data records from the primary computing system according to the instructions.

At least one other aspect of the present disclosure is directed to a system. The system can include a premises computing system comprising one or more processors and non-transitory memory. The premises computing system may be configured to authenticate, at a premises location, a user according to one or more authentication settings provided to the premises computing system. The user is associated with user data records stored by a primary computing system in communication with the premises computing system. The authentication settings authorize presentation and processing of a subset of the user data records. The premises computing system may be configured to monitor user input from the user via an input device of the premises computing system. The premises computing system may be configured to transmit, to a generative artificial intelligence system, a request to generate a response based on the user input, the request indicating the subset of the user data records. system can present, via an augmented reality device, at least one visualization generated based on the response received from the generative artificial intelligence system.

In some implementations, the premises computing system may be further configured to authenticate the user based on a near-field communication (NFC) signal from a mobile device of the user. In some implementations, the user input comprises audio data. In some implementations, the premises computing system may be configured to monitor speech input from the user based on the audio data captured via the input device of the premises computing system, the speech input processed using a text-to-speech model. In some implementations, the premises computing system may be configured to generate the at least one visualization to include one or more answers to the at least one question. In some implementations, the premises computing system may be configured to receive the response from the generative artificial intelligence system. The response can comprise at least one template. In some implementations, the premises computing system may be configured to generate the at least one visualization based on the at least one template of the response.

In some implementations, the premises computing system may be configured to authenticate a remote user via a remote computing system. In some implementations, the premises computing system may be configured to provide the at least one visualization to the remote computing system responsive to authenticating the remote user. In some implementations, the one or more authentication settings for the user authorize a second subset of the user data to be shared with the remote user. In some implementations, the premises computing system may be configured to determine that the at least one visualization is to be shared with the remote computing system based on the one or more authentication settings. In some implementations, the premises computing system may be configured to provide the at least one visualization to the remote computing system responsive to determining that the at least one visualization is to be shared with the remote computing system.

In some implementations, the premises computing system may be configured to provide a video stream to the remote computing system for display with the at least one visualization. In some implementations, the premises computing system may be configured to receive the response from the generative artificial intelligence system, the response including instructions to retrieve the subset of the user data records from the primary computing system. In some implementations, the premises computing system may be configured to generate the at least one visualization by retrieving the subset of the user data records from the primary computing system according to the instructions.

Yet another aspect of the present disclosure is directed to a non-transitory computer-readable medium. The non-transitory computer readable medium has instructions embodied thereon that, when executed by one or more processors of a premises computing system, cause the premises computing system to perform one or more operations. The one or more operations include authenticating, at a premises location, a user according to one or more authentication settings provided to the premises computing system. The user is associated with user data records stored by a primary computing system in communication with the premises computing system. The authentication settings authorize presentation and processing of a subset of the user data records. The one or more operations include monitoring user input from the user via an input device of the premises computing system. The one or more operations include transmitting, to a generative artificial intelligence system, a request to generate a response based on the user input, the request regarding the subset of the user data records. The one or more operations include presenting, via an augmented reality device, at least one visualization generated based on the response received from the generative artificial intelligence system.

In some implementations, the operations include generating the at least one visualization to represent a predicted cash flow using the response.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations, and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ may be interpreted as including one or more referents unless the context clearly dictates otherwise.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a block diagram of an example system for smart digital interactions with augmented reality and generative artificial intelligence, in accordance with one or more example implementations;

FIG. 1B is a block diagram of an example environment including an augmented reality device, in accordance with one or more implementations;

FIG. 2 is a component diagram of an example computing system suitable for use in the various arrangements described herein, in accordance with one or more example implementations;

FIG. 3 illustrates flow diagram of an example method of processing smart digital interactions with augmented reality and generative artificial intelligence, in accordance with one or more implementations; and

FIG. 4 illustrates a diagram showing an example graphical user interface that may be displayed via the augmented reality device shown in FIG. 1B, in accordance with one or more implementations.

### DETAILED DESCRIPTION

Below are detailed descriptions of various concepts related to, and implementations of, techniques, approaches, methods, apparatuses, and systems for smart digital interactions with augmented reality and generative artificial intelligence. The various concepts introduced above and discussed in detail below may be implemented in any of numerous ways, as the described concepts are not limited to any particular manner of implementation. Examples of specific implementations and applications are provided primarily for illustrative purposes.

Various embodiments described herein relate to smart digital interactions with augmented reality and generative artificial intelligence. Client applications can access resources from servers. In many cases, it can be challenging to capture and efficiently provide data for display based on a natural human input, particularly during real-time in-person interactions. These challenges are compounded when utilizing augmented reality systems, which often dedicate significant computational resources to generating augmented reality environments, introducing bottlenecks when attempting to efficiently process real-time input.

To address these and other issues, the systems, methods, and apparatuses described herein generate, enable, and provide systems for digital interactions within an augmented reality environment using one or more generative artificial intelligence models. The systems and methods described herein can receive and process requests for information in real-time and in a natural human format, and automatically generate graphical user interfaces in an augmented reality computing environment to communicate retrieved and/or generated information that is relevant to the received and/or monitored input data. The computing systems described herein can access or execute one or more generative artificial intelligence models to automatically generate the graphical user interfaces that communicate information efficiently and in real-time. The use of generative artificial intelligence in an augmented reality or virtual reality context provides an improved user experience by increasing immersion with richer content that can be generated on-demand based on natural human input. The graphical user interfaces may include any suitable information that may be related to user requests, including but not limited to, product features, contract terms and conditions, or card visuals (e.g., card art), among others. The graphical user interfaces may include interactive elements that can be used to receive user information or implement e-sign capabilities, among other functionality.

One example use case for the systems, methods, and apparatuses described herein include operations that provide real-time or near real-time data for financial decisions or financial management. Such environments may be implemented, for example, in banking branch locations or other locations where banking activities may occur. The generative artificial intelligence techniques described herein can be utilized to provide improved user experiences to retrieve, generate, and/or present custom-tailored graphical user interfaces or representations of relevant financial data. The systems, methods, and apparatuses described herein can utilize generative artificial intelligence to assist with financial planning, provide business projections based on spending or other financial information, as well as provide recommendations for business or personal financial decision-making.

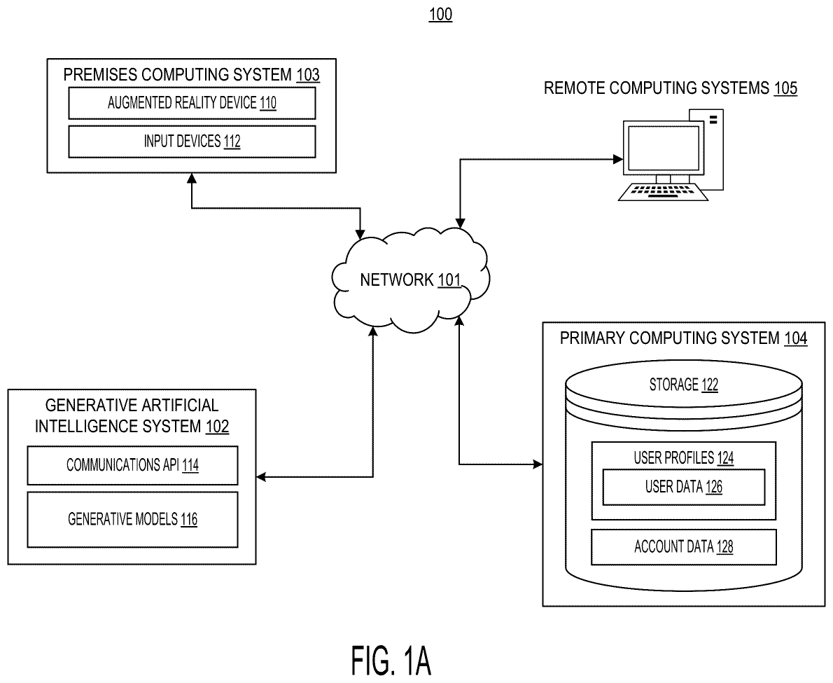

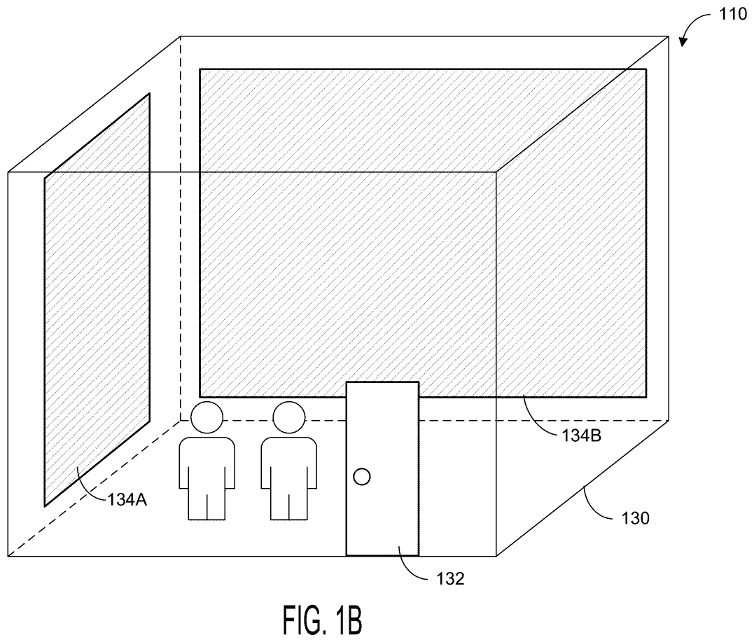

Referring to FIG. 1, illustrated is a block diagram of an example system 100 for smart digital interactions with augmented reality and generative artificial intelligence, in accordance with one or more example implementations. The system 100 may include a premises computing system 103, a generative artificial intelligence system 102, one or more remote computing systems 105, and a primary computing system 104. Each of the generative artificial intelligence system 102, the primary computing system 104, the one or more remote computing systems 105, and the premises computing system 103 can be in communication with one another via the network 101. The network 101 can facilitate communications among the premises computing system 103, the generative artificial intelligence system 102, the one or more remote computing systems 105, and the primary computing system 104 over, for example, the internet or another network via any one or more of various wired and/or wireless network protocols, such as Ethernet, Bluetooth, Cellular, or Wi-Fi.

Each component (e.g., of the system 100) may include one or more processors, memories, network interfaces, and/or user interfaces. The memory may store programming logic that, when executed by the processor, controls the operation of the corresponding computing device. The memory may also store data in databases. The network interfaces allow the computing devices to communicate wirelessly or otherwise. The various components of devices in system 100 may be implemented via hardware, software (e.g., executable code), or any combination thereof.

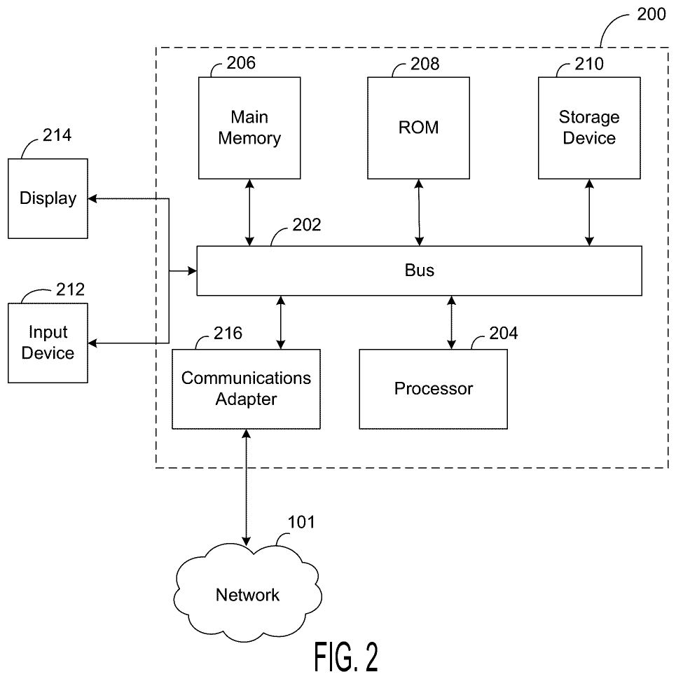

The generative artificial intelligence system 102 can include at least one processor and at least one memory to form at least one processing circuit. The memory can store processor-executable instructions that, when executed by a processor, cause the processor to perform one or more of the operations described herein. The processor may include one or more of a microprocessor, an application-specific integrated circuit (ASIC), a field-programmable gate array (FPGA), etc., or combinations thereof. The memory may include, but is not limited to, one or more of electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The generative artificial intelligence system 102 can include one or more computing devices or servers that can perform various functions as described herein. The generative artificial intelligence system 102 can include any or all of the components and perform any or all of the functions of the computer system 200 described herein in conjunction with FIG. 2.

The generative artificial intelligence system 102 may include one or servers, databases, or cloud computing environments that may execute one or more generative artificial intelligence models 116. The generative models 116 may include, but are not limited to, large language models (LLMs), which can be trained to generate human-like text, speech, images, or components of graphical user interfaces. The generative models 116 may be structured using a deep learning architecture that includes a multitude of interconnected layers, including attention mechanisms, self-attention layers, and transformer blocks. The generative models 116 are trained on large datasets to assimilate patterns, structures, and relationships within the data. The trained generative models 116 can be trained to generate outputs that closely resemble the characteristics of the input data. The generative models 116 may be fine-tuned to generate specific output data, including data that is compatible with various database architectures or augmented reality systems. The generative models 116 can be trained via optimization of a large number of parameters, in which the generative models 116 learn to minimize the error between its predictions and the actual data points, resulting in highly accurate and coherent generative capabilities.

The generative models 116 may be utilized to recognize and compute efficient outputs for different input data, including natural human input such as speech, text, or other types of input (e.g., videos, etc.). The generative models 116 may include trained speech-to-text models that can process speech into text data that may be ingested by large language models of the generative models 116. The speech-to-text models can be trained according to machine learning techniques such as supervised learning, unsupervised learning, or semi-supervised learning. The speech-to-text models may include architectures such as deep neural networks, recurrent neural networks (RNNs), and transformer-based architectures, which may be trained to recognize and transcribe speech signals.

The speech-to-text models can be trained on collections of audio data paired with corresponding transcriptions, such that the trainable parameters of the speech-to-text models are adjusted to enable the speech-to-text models to identify patterns in the spectral features of speech and associate them with the appropriate textual representations. The process for training the speech-to-text models can include optimizing trainable parameters that causes the speech-to-text models to minimize the discrepancy between generated transcriptions and the actual text data. The speech-to-text models can be trained to generate text data as output based on input speech data.

The speech-to-text models may be trained to handle variations in accents, dialects, speaking rates, and background noise. In some implementations, such speech to text models may be stored and executed by the premises computing system 103, as described in further detail herein. As described in further detail herein, monitored speech data at the premises computing system 103 can be transmitted to the generative artificial intelligence system 102, which can process the speech data and automatically generate a transcript of the monitored speech data using the speech-to-text model(s).

In some implementations, the transcript can be generated at the premises computing system 103, and may be transmitted to the generative artificial intelligence system 102 via the network 101. The generation of the transcript may be performed in real-time or near real-time, so as to generate a transcription of the meeting involving the user and any other participants as words are spoken. The transcript(s) may be provided to one or more operators of the premises computing system 103. Additionally, the speech-to-text models may automatically implement language translation capabilities. For example, the speech-to-text models may automatically convert text to speech, and then subsequently perform a translation process (which may be implemented at least in part by the generative models 116) to convert the input spoken language (e.g., Spanish) to an output desired language (e.g., English) in text format.

Real-time transcription performed by the generative artificial intelligence system 102 or the premises computing system 103 may be utilized to feed downstream systems, which may include the primary computing system 104, the remote computing devices 105, or other, external computing systems, such as third-party computing systems. The transcription may be stored, for example, as part of the user data 126 for the user participating in the meeting at the location of the premises computing system 103. Transcription may include recording words spoken during the meeting and translating the audio recording into machine-readable text data. In some implementations, the transcript may be provided as input to the generative models 116 in future meetings involving the user to provide context for the future meetings. For example, the generative models 116 may receive and process a previous transcription generated prior to the current meeting, and can generate talking points, recommendations, or follow-up questions relating to previously provided recommendations made during the past meetings. Information extracted from the transcription of one or more meetings may be provided to third party systems, such as consumer relationship management (CRM) systems, to populate databases, data records, or other information relating to the user.

Text data generated via the text-to-speech model(s) may be provided as input to the large language models of generative models 116. In the specific context of large language models, the generative models 116 can operate through a process of tokenization, wherein the input text is divided into individual tokens that represent words or sub-word units. The generated tokens are then embedded into a high-dimensional vector space, which enables the generative models 116 to capture and encode the semantic and syntactic relationships among the tokens. The transformer architecture facilitates the simultaneous processing of these tokens, effectively capturing dependencies and relationships across different parts of the input sequence. Self-attention mechanisms enables the generative models 116 to weigh the importance of each token in relation to others within the context, refining the representation of the input text data. Upon generating the output, the model selects tokens sequentially based on the highest probability of occurrence, as determined by the learned relationships in the training data.

The generative models 116 may include a number of output layers that are fine-tuned to specific applications. For example, the output of one or more of the generative models 116 can be controlled and guided during a fine-tuning process by introducing task-specific loss functions or constraints, which help can be utilized to optimize and specify particular application-specific outputs of the generative models 116. In some implementations, one or more of the generative models 116 may be trained using a fine-tuning process to automatically generate database entries or to automatically identify relevant database entries for users based on text input. For example, the one or more of the generative models 116 may be utilized to identify or otherwise generate instructions to retrieve data from one or more databases corresponding to user data, such as the user data 126 of a user profile 124, or account data 128, of a particular user. One or more of the generative models 116 may also be fine-tuned to generate, or otherwise select, presentation formats that may be utilized to generate graphical user interfaces to display information retrieved from different databases or storage media described herein.

The generative models 116 stored at the generative artificial intelligence system 102 can be accessed, for example, by the premises computing system 103 or the primary computing system 104 using one or more communications application programming interfaces (API) 114. The primary computing system 104 can maintain and provide the communications API 114. The communications API 114 can be any type of API, such as a web-based API corresponding to a particular network address uniform resource identifier (URI), or uniform resource locator (URL), among others. The communications API 114 can be accessed, for example, by one or more of the premises computing system 103 or the primary computing system 104, via the network 101. The communications API 114 can be a client-based API, a server API (SAPI), or an Internet Server API (ISAPI).

Various protocols may be utilized to access the communications API 114, including a representational state transfer (REST) API, a simple object access protocol (SOAP) API, a Common Gateway Interface (CGI) API, or extensions thereof. The communications API may be implemented in part using a network transfer protocol, such as the hypertext transfer protocol (HTTP), the secure hypertext transfer protocol (HTTPS), the file transfer protocol (FTP), the secure file transfer protocol (FTPS), each of which may be associated with a respective URI or URL.

The communications API 114 may be exposed to the premises computing system 103 or the primary computing system 104, which can execute one or more API calls to perform the various operations described herein. In an embodiment, the premises computing system 103 or the primary computing system 104 include an API that is similar to the communications API 114, which the premises computing system 103 or the primary computing system 104 can use communicate with other computing devices to perform the various operations described herein.

Any suitable data may be transferred via the various APIs to implement the various techniques described herein. The communications API 114 may further enable communication with a variety of downstream systems via corresponding API endpoints. For example, the communications API 114 may enable integration with one or more CRM systems or credit models, among other systems.

The premises computing system 103 can include at least one processor and at least one memory to form or create at least one processing circuit. The memory can store processor-executable instructions that, when executed by a processor, cause the processor to perform one or more of the operations described herein. The processor may include one or more of a microprocessor, an ASIC, an FPGA, etc., or combinations thereof. The memory may include, but is not limited to, one or more of electronic, optical, magnetic, or any other storage or transmission device capable of providing the processor with program instructions. The memory may further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions may include code from any suitable computer programming language. The premises computing system 103 can include one or more computing devices (e.g., desktop computers, laptop computers, servers, smartphones, tablets, etc.) that can perform various functions as described herein. Each premises computing system 103 can include any or all of the components and perform any or all of the functions of the computer system 200 described herein in conjunction with FIG. 2.

The premises computing system 103 may include an on-premises computing system (e.g., a computing system within a building such as a branch location associated with a provider), which may provide augmented reality output via the augmented reality device 110. The premises computing system 103 may utilize one or more input devices 112 to receive and store environmental data, such as speech data, video data, user-input data (e.g., input data via text, selections, etc.). The input device(s) 112 can include touch screens, microphones, video cameras, keyboards, mice, or other types of input devices that may be operated to capture any type of input described herein.

The augmented reality device 110 of the premises computing system 103 may include one or more large screens, which may cover one or more surfaces of a room. For example, the augmented reality device 110 may include one or more large wall-mounted display devices, which may be light-emitting diode (LED) displays, organic light-emitting diode (OLED) displays, liquid crystal displays (LCDs), or other types of displays that may display any of the graphical user interfaces described herein. The augmented reality device 110 may present information in real-time that may be provided from the primary computing system 104, the generative computing system 102, or other, external computing devices or systems via the network 101. In some implementations, the augmented reality device 110 may receive instructions to display or generate one or more graphical user interfaces from the primary computing system, as described herein.

The premises computing system 102 may communicate with the primary computing system 104 to retrieve various user data 126 form the user profiles 124 of specified or detected users. Additionally, the premises computing system 102 may access the account data 128 of one or more users, businesses, trusts, or other types of entities. In some implementations, the premises computing system 102 may transmit requests for data to the primary computing system 104, and the primary computing system 104 can access and retrieve said data. In some implementations, natural language transcript data, audio speech data, or other natural human input data may be provided to the provider computing system 104, which may process said data via transmissions to the generative artificial intelligence system 103. The generative artificial intelligence system 103 may process the request data using the generative models 116, and provide instructions to access one or more database entries at the primary computing system 104. In some implementations, the generative models may be maintained and executed by the primary computing system 104 or the premises computing system 102, while achieving similar results.

In some implementations, one or more display or output devices (including, in some implementations, the augmented reality devices 110) of the premises computing system 103 can present one or more user interfaces, for example, in response to user input or interactions with displayed interactive user interface elements. The user interfaces can be utilized to present information to the user or to receive information or input from the user. In an embodiment, the user interfaces can prompt the user to capture authentication data, including usernames, passwords, emails, personal identification numbers (PINs), account numbers, and/or biometric scan data (e.g., images of the user's face, fingerprint scans, one or more voice samples, an iris scan (or an image of the user's eye), palm or finger vein patterns, retinal scans, etc.). The user interface may include interactive elements that, when interacted with, cause the premises computing system 103 to transmit one or more requests, data packets, or other data related to the techniques described herein. Input may be provided via the input device(s) 112.

The premises computing system 103 can receive display instructions to display various content (e.g., text, graphics, video, prompts, alerts, notifications, indications, etc.) from the primary computing system 104 or from the generative artificial intelligence system 102. In some implementations, the premises computing system 103 may receive instructions to generate graphical user interfaces based on information received from the primary computing system 104 or from the generative artificial intelligence system 102. The graphical user interfaces can include any type of interactive user interface element, including those that enable a user to provide information that can be stored in the user profiles 124, to send requests, or to navigate between different graphical user interfaces or graphical elements of user interfaces. For example, interactions with one or more graphical user interfaces or interactions (e.g., speech, text input, etc.) detected by the input device 112 may automatically cause the premises computing system 102 to transmit requests to the generative artificial intelligence system 102 as described herein.

The premises computing system 103 may include various input devices 112, which may be utilized to monitor natural human speech, motion, or may be utilized for authentication purposes. The input devices 112 may include biometric sensors or ambient sensors, or any other type of sensor capable of capturing information about a user or an environment in which the user is present. The input devices 112 can include components that capture images, video, ambient lights, and sounds. Examples of such sensors can include cameras and microphones. The input devices 112 of the premises computing system 103 may include keyboards, mice, touchscreens, or other types of input devices enable one or more users to provide inputs.

The premises computing system 103 may provide an integrated user experience, in which graphical user interfaces or other output is dynamically generated and displayed via the augmented reality device 110, for example, in a conference room or presentation room. The premises computing system 103 may communicate with the primary computing system 104 and/or the generative artificial intelligence system 102 perform the various techniques described herein, including the generation of graphical user interfaces to dynamically present content relating to natural human speech provided by users.

Additionally, the premises computing system 103 can generate graphical user interfaces, which may be interactive, to provide insights relating to projections of user or business assets, spending, cash flow, or other types economic scenarios. The graphical user interfaces generated and provided by the premises computing system 103 can include any information relating to banking, personal finance recommendations, business decisions, business assets, or visualizations of finance-related data. When generating graphical user interfaces that include finance-related data, the premises computing system 103 may receive, identify, or otherwise generate (e.g., via one or more templates) various visualizations to provide an optimal presentation of the information via the augmented reality device 110 (or another type of display device). The visualizations may include graphs with annotations, comparison charts, tables, or other types of visualizations that are optimized for financial data. The premises computing system 103 may provide graphical user interfaces that enable users to deposit funds into accounts, withdraw funds from accounts, transfer funds between accounts, view account balances, or other online banking actions via one or more display devices (including, for example, the augmented reality device 110).

In some implementations, the premises computing system 103 may present an interactive graphical user interface based on information communicated by a user, and can receive and update the user data 126 of the user profile 124 in response to input from a corresponding user. In some implementations, the input data provided by the user may be processed via the generative models 116, which may be utilized to generate corresponding database entries that are stored within the storage 122. The premises computing system 103 may communicate information input by the user (e.g., speech, touch or keyboard input, etc.) to the generative artificial intelligence system 102, which can utilize the generative models 116 to generate lookup commands for corresponding database entries that are relevant, for example, to a conversation involving a user. Said database entries can be utilized to retrieve corresponding user data 126 from a user profile 124 of the user, which can then be utilized to generate dynamic graphical user interfaces for display via the augmented reality device 110.

The graphical user interfaces generated by the premises computing system 103 and displayed via the augmented reality device 110 can include information retrieved from third-party computing systems. For example, the premises computing system 103 may invoke one or more APIs of third-party computing systems to retrieve information relating to the user for integration with the graphical user interfaces displayed via the augmented reality device 110. Third-party systems may include, for example, credit reporting systems, customer relation management systems, or user-specific data sources (e.g., an email account of the user stored at an email server, social media data of the user stored at a social media system, etc.), among others. In some implementations, the APIs may utilize corresponding authentication information for the third-party system to provide access to the third-party computing systems or to user-specific data. The user may provide authentication credentials (e.g., login information, PIN, two-factor code, etc.) to access the third-party computing systems or user-specific data via the input device 112.

The premises computing system 103 may transmit any information retrieved from the third-party computing systems to the generative artificial intelligence system 102, for example, to provide context or additional information in connection with the conversations that occur during the meeting with the user. For example, the user may inquire about a loan, and the premises computing system 103 may transmit the user's credit information, retrieved from a third-party credit reporting system, to the generative artificial intelligence system 102 to generate one or more loan recommendations. The loan recommendations may then be displayed to the user at the premises computing system 103 via the augmented reality device 110.

Information retrieved from the third-party computing systems may be integrated with the graphical user interfaces presented via the augmented reality device 110. To do so, the premises computing system 103 may receive indications from the generative artificial intelligence system 102 to retrieve or present certain data from third-party systems, such as credit information, external financial account information, or other types of information relevant to the user or to a particular context identified by the generative artificial intelligence system 102. The data from third-party systems may be presented in addition to recommendations or data generated by or retrieved from the generative artificial intelligence system 102 or the primary computing system 103, enabling seamless integration between information in the user data 126, the account data 128, generated visualizations, and third-party data.

The premises computing system 103 may communicate with the one or more remote computing systems 105, which may be user devices such as personal computers, laptops, smartphones, mobile devices, tablets, or other types of computing devices. For example, the remote computing systems 105 may include one or more of the processors, memory, and input/output devices described herein. The remote computing systems 105 may execute applications that enable a remote user to establish a communication channel with the premises computing system 103.

The premises computing system 103 can execute a communication application, such as a chat application, a video call application, or a virtual meeting application, to initiate a communication session with one or more remote computing systems 105. In some implementations, user input can be utilized to specify the remote computing systems 105 to which to connect for the communication session. Output from the communication session may be presented dynamically as part of the graphical user interfaces displayed via the augmented reality devices 110. In some implementations, the remote users communicating via the remote computing system(s) 105 may be authenticated (e.g., via the primary computing system 104) prior to initiating the communication session or prior to presenting output of the communication session via the augmented reality device 110. In some implementations, all, portions, or information utilized to generate the various graphical user interfaces presented via the augmented reality device 110 may be provided to the remote computing system(s) 105 for display as part of the communication session. In some implementations, following authentication of the remote user(s) communicating via the remote computing system(s) 105, personal data of the remote user(s) can be retrieved for use by the communication session (e.g., to make the interactions via the augmented reality device 110 more personal, etc.).

The primary computing system 104 can include at least one processor and at least one memory (e.g., at least one processing circuit). The memory can store processor-executable instructions that, when executed by the processor, cause the processor to perform one or more of the operations described herein. The processor may include one or more of a microprocessor, an ASIC, an FPGA, etc., or combinations thereof. The memory may include, but is not limited to, one or more of an electronic, optical, magnetic, or any other storage or transmission device capable of providing the processor with program instructions. The memory may further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions may include code from any suitable computer programming language. The primary computing system 104 can include one or more computing devices or servers that can perform various functions as described herein. The primary computing system 104 can include any or all of the components and perform any or all of the functions of the computer system 200 described herein in conjunction with FIG. 2.

The primary computing system 104 can be a computing system of, owned by, managed by, and/or otherwise associated with an entity that maintains various user profiles (e.g., the primary profiles 124) for a number of different users. The primary computing system 104 can provide information to the premises computing system 103 during a presentation or session with a user, such as information that may be utilized to generate one or more dynamic graphical user interfaces, instructions to carry out one or more functionalities described herein, or other information relating to one or more of primary profiles 124, the user data 126 stored therein, or corresponding account data 128 of one or more users.

In some embodiments, the primary computing system 104 may be the computing system associated with a provider institution, such as a financial institution, that provides financial services (e.g., demand deposit accounts, credit accounts, etc.) to a plurality of customers, and may thus be a financial institution computing system. The financial institution computing system may provide banking services to user devices (e.g., the remote computing systems 105, the premises computing system 103, etc.) by, for example, allowing users to use a client application running on the user devices 103 to, for example, deposit funds into accounts, withdraw funds from accounts, transfer funds between accounts, view account balances, and the like.

For example, the primary computing system 104 can receive information provided via the premises computing system 103, and can provide queries or the natural human input data to the generative artificial intelligence system 102. The primary computing system 104 may receive identifiers of database entries, or identifiers of types of data to retrieve for a user based on the input data monitored at the premises computing system 103. The primary computing system 104 may access said information, and transmit said information to the premises computing system 103 in real-time or near real-time, such that the premises computing system 103 can dynamically generate graphical user interfaces to display said information during a session with a user.

The primary computing system 104 may implement functionality to authenticate users, and to create or modify user profile 124 information (e.g., the user data 126, the user profiles 124 themselves, etc.) for a user. For example, a user can utilize the premises computing system 103 to communicate with the primary computing system 104, for example, to create, modify, delete, and/or authorize retrieval of information (e.g., the user data 126) in connection with a user profile 124 associated with the user. The primary computing system 104 can be a backend computer system that interacts with the premises computing system 103 and supports various services offered by the primary computing system 104, such as information technology (IT) services or network management services.

The primary computing system 104 can include a storage 122, which may be any type of computer-accessible memory or database that can maintain, manage, or store primary profiles 124, for example, in one or more data structures. Each of the user profiles 124 may correspond to a respective user and may be identified by a corresponding user identifier (e.g., a username, an email address, a passcode, an encryption key, etc.). The user profiles 124 can include user data 126 corresponding to the respective user. The user data 126, along with any other information associated with a user, may be created, updated, or deleted according to input received via the premises computing system 103, the generative artificial intelligence system 102, or one or more remote computing systems 105.

The user data 126 may include personally identifying data (e.g., name and social security number), psychographics data (e.g., personality, values, opinions, attitudes, interests, and lifestyles), financial data such as transactional data (e.g., preferred products, purchase history, transaction history, income history, credit score, asset types and amounts, balance information across various accounts, such as demand deposit accounts, and so on), demographic data (e.g., address, age, education), and/or other user or user account data that is maintained or otherwise accessible to the primary computing system 104. The primary computing system 104 can receive requests to update the user profile 124 for a user from the premises computing system 103, for example, in a request with a corresponding authentication token, login information, or other information corresponding to a successful authentication of the corresponding user. The user profiles 124 can be accessed via user input at a premises computing system 103, as described herein. In some implementations, the user profile 124 or the user data 126 can identify one or more remote computing systems 105 of the user to which the user profile 124 corresponds (e.g., and additional remote computing systems 106 that may be registered to the user profile 124 by way of request including two-factor authentication, for example).

The storage 122 may store information relating to one or more financial accounts in the account data 128. The account data 128 may store any information relating to one or more financial accounts of a user. The account data 128 may be stored in association with one or more corresponding user profiles 124. Any finance-related information may be stored in the account data 128, including but not limited to data associated with multiple financial accounts, such as checking, savings, credit cards, loans, and investments, as well as information such as account balances, transaction history, interest rates, fees, and terms and conditions associated with financial account or loans of the user. The account data 128 may include further user-specific data, including income, expenses, financial goals, and risk tolerance information.

The primary computing system 104 may provide any corresponding account data 128 to the premises computing system 104 to provide users with a holistic view of their financial health and to assist in identifying potential opportunities for improvement or optimization. In some implementations, the primary computing system 104 can communicate with the premises computing system 103 to dynamically generate graphical user interfaces that provide targeted insights and actionable advice on topics such as budgeting, debt management, investment strategies, and overall financial planning. The primary computing system 104 may communicate with the generative artificial intelligence system 102 to execute the generative models 116, to select visualizations to generate graphical user interfaces in a dynamic, adaptive, and user-friendly format. In some implementations, the primary computing system 104 may coordinate authentication via credentials (e.g., username, password, security tokens, etc.) for remote computing system(s) 105 being added to a session with one or more users interacting with the premises computing system 103.

In an example use case of the system 100, recommendations may be automatically generated for a user during a meeting in a conference room that includes one or more components of the premises computing system 103, such as the augmented reality device 110 and one or more input devices 112. Furthering this example, the user may begin interacting with the premises computing system 103 after entering a location associated with the primary computing system 104 (e.g., a branch location of a bank, etc.). When at the location, the user may communicate with other users at the location, and can initiate a session with the premises computing system 103 to receive advice, guidance, or recommendations generated based upon information in the user data 126 of the user profile 124 of the user and the account data 128 of the user.

For example, the user may enter a room or an area in which the augmented reality device 110 is positioned, and can present information to the user. The input devices 112 can monitor and detect any input provided by the user, including natural language speech, text input, video input, biometric data input, or other types of input. In some implementations, the user can provide information that may be utilized to authenticate the user, such as a username, password, or other identifying or authentication information, before the session can be initiated at the premises computing system 103. The data provided by the user may be authenticated via communication with the primary computing system 104 via the network 101.

In some implementations, once the user is authenticated, the doors to the room may be automatically opened, closed, and/or or locked so as to prevent presentation of personal information to unintended or unauthorized persons. In some implementations, the premises computing system 103 may control one or more glass walls (e.g., privacy glass) of the room, causing the glass walls to appear opaque. Different authentication procedures may be performed to show certain information during the session. For example, the input devices 112 may perform different “levels” of authentication, each of which correspond to respective authentication procedure(s) and personal data that may be presented during the session once the respective authentication procedure(s) are completed. The authentication procedure(s) may include a wireless communication via near-field communication (NFC) (e.g., tapping a smartphone on a contactless reader), entering a valid personal identification number (PIN), or a biometric scan, a Bluetooth or other wireless connection with the premises computing system (which indicates that the mobile device is nearby), among others.

Data presented during the session may be controlled via user preferences, which may be stored as part of the user profile 124 of the user data. Using an application executing on a smart phone or other type of user device, the user may identify what user data 126 of the user profile 124 can be shared via the augmented reality device 110. When the premises computing system 103 makes requests to the primary computing system 104 to retrieve and display user data 126, the primary computing system 104 can provide the user data 126 that the user has authorized to be provided. In some implementations, the preferences defined via the user device may be transmitted wirelessly (e.g., via NFC, Bluetooth, Wi-Fi, etc.) to the premises computing system 103, which may only request and display data that the user has authorized.

Once the user is authenticated, the input device 112 of the premises computing system 103 can monitor input from the user, which may include questions, requests relating to the user data 126, the user profile 124, or the account data 128 of the user, future planning or goals, projections, or other types of input relating to the data stored at the primary computing system 104. Based on the user input, the premises computing system 103 can communicate with the primary computing system 104 to retrieve relevant information, and utilize the retrieved information to construct dynamic graphical user interfaces that display the retrieved information.

In some implementations, the premises computing system 103 can communicate the user input to the generative artificial intelligence platform 102. In some implementations, the premises computing system 103 can communicate the user input to the primary computing system 104, which can subsequently transmit said information to the generative artificial intelligence system 102. The generative artificial intelligence system 102 can execute the generative models 116 to generate lookup commands at the storage 122 for corresponding database entries that are relevant, for example, to a conversation involving the user. The lookup commands may be commands that can be interpreted or executed by the primary computing system 104 to retrieve corresponding information relating to the user's input, or input from other users at the location of the premises computing system 103 (e.g., branch employees, etc.). For example, the commands may be commands to look up a type of information in the user data 126, such personal information (e.g., age, employment information, etc.), or information in the account data 128, such as account balances, projects, or asset distribution, among others.

During the session with the user at the location having the premises computing system 103, users that operate the premises computing system 103 (e.g., branch employees) may receive prompts from the primary computing system 104 or the generative artificial intelligence system 102 based on the user's input. For example, the prompts may include recommendations, answers to questions provided by the user, or other information that may be useful to communicate to the user in-person. The prompts may be provided in response to one or more goals identified by the user, and may be utilized to answer questions relating to financial recommendations, including value propositions, benefits, discounts, interest rate details, products or services that are available to the user, retirement goals or discussions, budget and portfolio overviews, or other types of recommendations, projections, or data. In some implementations, the generative models 116 of the generative artificial intelligence system 102 may generate full responses to the user based on the user's input. In some implementations, the generative models 116 of the generative artificial intelligence system 102 may generate customized plans based on the user's input, the user data 126 of the user, or account data 128 of the user, among other information. The customized plan may be plans to meet certain savings goals given current expenses, assets, and income, goals purchase certain assets such as homes, or goals to pay off loans within predetermined time periods, among others.

In some implementations, one or more operators of the premises computing system 103 (e.g., branch employees) can provide input to the premises computing system 103 to initiate a communication session with one or more remote users via the remote computing devices 105. The remote user may be associated with the user for which the session is conducted (e.g., a spouse, relative, financial planner, lawyer, etc.). In some implementations, the one or more remote users may be remote experts that join the operators of the premises computing system 103 in providing recommendations or feedback to the user's input. To do so, the premises computing system 103 may initiate one or more communication sessions with one or more identified remote computing devices 105, as described herein. Initiating the remote communication session may include authenticating the remote users, as described herein.

If the communication session includes a video stream (e.g., captured by a camera and microphone of the remote computing device 105), the video stream may be displayed in part by the augmented reality device 110. In some implementations, the premises computing system 103 can automatically generate one or more graphical user interfaces that integrate the video stream with other graphical elements generated that display various information retrieved from the primary computing system 104. The video stream may be displayed via the augmented reality system 110 to facilitate a multi-user conversation in the room, along with any operators of the premises computing system 103.

For example, the premises computing system 103 may dynamically update, reposition, or otherwise modify presently displayed graphical user interface elements to accommodate the incoming video stream. Video from the room in which the session with the user at the location of the premises computing system 103 may also be streamed to the remote computing system(s) 105 as part of the communication session. The premises computing system 103 can further transmit all, or portions of, the dynamically generated user interfaces displayed by the augmented reality device 110.

The premises computing system 103 can automatically generate graphical user interfaces that can be displayed via the augmented reality device 110 based on the user-provided input (e.g., speech, text input, video input, etc.). For example, the premises computing system 103 may receive identifiers of types of visualizations from the generative artificial intelligence system 102 or primary computing system 104. The visualizations may include identifiers of graphical user interface elements, layout instructions, display instructions, graphics, or instructions to process data, which can be utilized to display various information retrieved from the primary computing system 104. The visualizations may be generated, for example, based on the type of data retrieved from the primary computing system 104. For example, spending habits may be represented in a graph format, along with changes in income, account balances, or other time-series financial data.

In some implementations, the primary computing system 104 may provide instructions that cause the premises computing system 103 to retrieve data from one or more external webservers or content sources. The resulting graphical user interfaces may be generated by the premises computing system 103 and displayed via the augmented reality device 110. The instructions may be received on a continuous or a semi-continuous basis, such that the graphical user interfaces can be updated with additional content, recommendations, or information derived from the user data 126 or the account data 128.

The graphical user interfaces displayed via the augmented reality device 110 may be synchronized with recommendations or talking points provided by one or more operators of the premises computing system 103. In some implementations, the operators of the premises computing system 103 may provide input to advance or otherwise change or modify the graphical user interfaces displayed via the augmented reality device 110. Changing the visualizations may include providing input that causes the premises computing system 103 to transmit requests for particular information, or providing input that causes the premises computing system 103 to display alternative or additional visualizations for data related to the user.

The visualizations may take the form of graphs, charts, graphical elements such as images, text, video, or other types of visual content. The graphical user interface elements presented by the augmented reality device 110 may include animations of benefits, recommendations, or value propositions, which may populate the augmented reality device 110 on queue (e.g., in response to operator input) to augment the operator's presentation or to provide insight into a recommendation or statement made by the operator. In some implementations, the operator may be provided talking points or text that includes responses to user questions. As described herein, the visualizations and graphical user interface elements can be dynamically updated according to user and operator conversations (e.g., regarding cash flow, investment research, etc.). Various data may be displayed via the visualizations, including balance reports, spending summaries, account balance information, income projections, transaction history, and income history, credit score, asset types and amounts, among others.

In some implementations, authentication may be performed via the premises computing system 103 to perform one or more transactions or actions at one or more external systems, such as automated teller machines (ATMs) or lock boxes. For example, the user, while participating in the session, may request withdrawal of funds from an ATM to complete one or more transactions. In response to the request, the premises computing system 103 may generate and provide a code to the user corresponding to the withdrawal of funds. The code may be transmitted to, or generated by and received from, the primary computing system 104. The code may be stored in association with the transaction, corresponding account information, or other information provided during the session, for example, as part of the account data 128. The code may be a bar code, a QR code, a PIN, or another type of code that may be accessed by the user.

Once the code has been received by the user, the user may access an ATM or a lockbox to complete the transaction. In an example where the transaction is completed at an ATM, the user may access the ATM to provide the code. Once provided to the ATM, the ATM can transmit the code to authenticate the transaction via the primary computing system 104. For example, the primary computing system 104 may compare the code received from the ATM to the code stored previously during the session with the user. If the codes match, the primary computing system 104 may authorize completion of the transaction (e.g., a withdrawal) at the ATM by transmitting a corresponding signal to the ATM.

Similar techniques may be utilized to complete a transaction at a lockbox, where the transaction is complete once the lockbox is opened. For example, the user can input the code to the lockbox via one or more input devices (e.g., keypad, touchscreen, contactless scanner, etc.) of the lock box. Once provided to the lock box, the lock box can transmit the received code to authenticate the transaction via the primary computing system 104. For example, the primary computing system 104 may compare the code received from the lock box to the code stored previously during the session with the user. If the codes match, the primary computing system 104 may authorize access to the lock box by transmitting a corresponding signal to the lock box, causing it to open.

Although the foregoing example has been described as being performed in an in-person environment, it should be understood that similar techniques may be performed in a remote environment. For example, the user may communicate remotely with the premises computing system 103 via one or more remote computing devices 105, and can initiate a session, view visualizations, and provide questions or conversational input via the input/output devices of the remote computing devices 105.

In another example use case, the premises computing system 103 may provide functionality to assist business owners with cash flow projections, debt management, asset management, and other types of recommendations. In this example, the user may be a business owner that communicates with the premises computing system 103 remotely via a remote computing device 105 or in-person, as described herein.

The user (or an operator of the premises computing system 103) can initiate a session with the premises computing system 103 as described herein, with a focus on business planning and management. In some implementations, information specific to the business(es) at issue may be authenticated prior to initiating the session with the user. In addition, the user may themselves be authenticated as described herein. The user and the operator of the premises computing system 103 can then engage in a conversation relating to business concerns or other similar topics. The input device 110 can receive the input (e.g., in-person or remotely via the remote computing device 105) from the user, and can provide said input data to the generative artificial intelligence system 102 and/or the primary computing system 104, as described herein.

In some implementations, the user profiles 124 may include profiles for businesses. The user data 126 stored in said profiles may include any data related to a business, including but not limited to business assets, business capital, records, or other types of business data. The account data 128 may also include additional business-related content, as well as projections for multiple scenarios of cash flow. In such implementations, the primary computing system 104 may provide details relating to the business to the premises computing system 103, using techniques similar to those described herein. The primary computing system 104 or the premises computing system 103 may communicate with the generative artificial intelligence system 102 to generate business-specific projections or recommendations.

For example, the primary computing system 104, based on data received from the premises computing system 103 or the remote computing device 105, can provide instructions for the premises computing system 103 or the remote computing device 105 to generate interactive visuals or animations to augment data collection or information gathering, which may be automatically stored as part of business records in a corresponding profile 124 for the business. Any suitable data may be stored in corresponding entries of the account data 128 or the user data 126 for the business, including any changes to business assets, accounts, or other finance-related data.

Various visualizations may be generated for any type of business attribute, recommendation, or metric, including those for small or medium businesses. Such visualizations may include graphical interfaces that show the current health of the business, a listing of business assets, a listing of business customers, or other commercial information related to the business. Financial information such as visualizations that represent recent expenses paid by the business may be presented in the visualizations. As described herein, the visualizations may be presented via the augmented reality device 110.

Visualizations may also be generated to provide projections of resource (e.g., cash, etc.) flow or scenario modeling for different business decisions. For example, the premises computing system 103 or the remote computing device 105 may receive instructions to generate dynamic cash flow projections, which may be dynamically updated based on real-time input from the user and the operator of the premises computing system 103. The input from the user and the operator may include conversational input that is processed by the generative models 116, which may be fine-tuned or otherwise trained to generate visualizations for different modeling techniques. In some implementations, the generative models 116 may provide indications of modeling techniques to user to model particular scenarios discussed during the conversation. The modeling may be executed by the primary computing system 104, the remote computing device 105, or the premises computing system 103 t generate real-time visualizations of various business scenarios.

The operator may also receive business-specific prompts or suggestions to provide to the user that initiate the session for the business. For example, the generative models 116 may be executed to automatically generate prompts for the operator to achieve certain objectives or to provide recommendations for business decisions. The prompts may be provided by the generative artificial intelligence system 102 in real-time or near real-time, as the conversation between the operator and the user unfolds. The prompts may include business solutions, or recommendations that accompany cash flow projections or business scenario simulations. The visualizations for the business may take the form of graphs, charts, graphical elements such as images, text, video, or other types of visual content. The graphical user interface elements may be presented by the remote computing device 105 or the augmented reality device 110 of the premises computing system 103. As described herein, the visualizations and graphical user interface elements can be dynamically updated according to user and operator conversations (e.g., regarding cash flow, investment research, etc.).

Although the generative models 116 are described as being executed by the generative artificial intelligence system 102, it should be understood that any computing device described herein may maintain and execute the generative models 116 to achieve useful results. Likewise, although certain interactions may be described as occurring in person or on-premises, it should be understood that similar techniques may be carried out remotely via one or more remote computing devices 105.

For example, a user of a remote computing device 105 may access a web-based interface of the premises computing system 103, the primary computing system 104, or the generative artificial intelligence system 102, which may provide the dynamic visualizations via the network 101. In such implementations, one or more remote operators may communicate with a user via a second remote computing device 105. Input at each remote computing device 105 can be monitored as described herein and provided to the computing devices of the system 100 to generate dynamic and real-time visualizations, as well as perform any processing techniques described herein.

FIG. 1B is a block diagram of an example environment including an augmented reality device, in accordance with one or more implementations. FIG. 1B shows an embodiment of the augmented reality device 110. As shown, the augmented reality device 110 may take the form of, or be included within, a room 130. The room 130 may have a door 132, which may be automatically secured or locked upon authenticating one or more users within the room 130. As shown, the augmented reality device 110 may include multiple display devices 134A and 134B.

Although shown here as including only two display devices 134A and 134B, the augmented reality system may include any number of display devices which may be utilized to present various visualizations of user data, as described herein. The display devices 134A and 134B may be in communication with the premises computing system 103, which may be positioned within or outside of the room 130. The room 130 may also include one or more input devices 112, which can monitor input from the user while the user is within the room for use in the techniques described herein.

FIG. 2 is a component diagram of an example computing system suitable for use in the various implementations described herein, according to an example implementation. For example, the computing system 200 may implement an example generative artificial intelligence system 102, premises computing system 103, remote computing device 105, or primary computing system 104 of FIG. 1, or various other example systems and devices described in the present disclosure.

The computing system 200 includes a bus 202 or other communication component for communicating information and a processor 204 coupled to the bus 202 for processing information. The computing system 200 also includes main memory 206, such as a RAM or other dynamic storage device, coupled to the bus 202 for storing information, and instructions to be executed by the processor 204. Main memory 206 can also be used for storing position information, temporary variables, or other intermediate information during execution of instructions by the processor 204. The computing system 200 may further include a read only memory (ROM) 208 or other static storage device coupled to the bus 202 for storing static information and instructions for the processor 204. A storage device 210, such as a solid-state device, magnetic disk, or optical disk, is coupled to the bus 202 for persistently storing information and instructions.

The computing system 200 may be coupled via the bus 202 to a display 214, such as a liquid crystal display, or active matrix display, for displaying information to a user. An input device 212, such as a keyboard including alphanumeric and other keys, may be coupled to the bus 202 for communicating information, and command selections to the processor 204. In another implementation, the input device 212 has a touch screen display. The input device 212 can include any type of biometric sensor, or a cursor control, such as a mouse, a trackball, or cursor direction keys, for communicating direction information and command selections to the processor 204 and for controlling cursor movement on the display 214.

In some implementations, the computing system 200 may include a communications adapter 216, such as a networking adapter. Communications adapter 216 may be coupled to bus 202 and may be configured to enable communications with a computing or communications network 101 and/or other computing systems. In various illustrative implementations, any type of networking configuration may be achieved using communications adapter 216, such as wired (e.g., via Ethernet), wireless (e.g., via Wi-Fi, Bluetooth), satellite (e.g., via GPS) pre-configured, ad-hoc, LAN, WAN, and the like.

According to various implementations, the processes of the illustrative implementations that are described herein can be achieved by the computing system 200 in response to the processor 204 executing an implementation of instructions contained in main memory 206. Such instructions can be read into main memory 206 from another computer-readable medium, such as the storage device 210. Execution of the implementation of instructions contained in main memory 206 causes the computing system 200 to perform the illustrative processes described herein. One or more processors in a multi-processing implementation may also be employed to execute the instructions contained in main memory 206. In alternative implementations, hard-wired circuitry may be used in place of or in combination with software instructions to implement illustrative implementations. Thus, implementations are not limited to any specific combination of hardware circuitry and software.

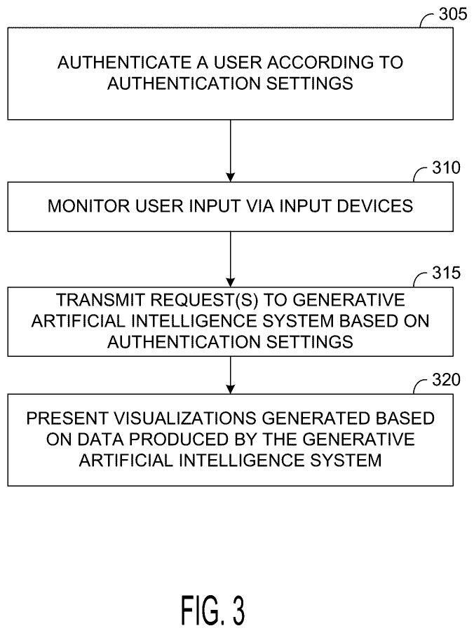

FIG. 3 illustrates flow diagram of an example method 300 of processing smart digital interactions with augmented reality and generative artificial intelligence, in accordance with one or more implementations. Method 300 may be implemented using the system 100. In one implementation, additional, fewer, and/or different operations may be performed. It will be appreciated that the order or flow of operations indicated by the flow diagrams and arrows with respect to the methods described herein is not meant to be limiting. For example, in one implementation, two or more of the operations of method 300 may be performed in parallel.

At step 305 of the method 300, a premises computing system (e.g., the premises computing system 103) can authenticate a user according to authentication settings provided to the premises computing system. The authentication settings may be provided via a wireless transmission from mobile device of the user, or provided via an input device (e.g., the input device(s) 112) of the premises computing system. The authentication settings may indicate particular data records of the user stored at a primary computing system (e.g., the primary computing system 103) that are authorized for processing via an generative artificial intelligence system 102 or presentation via an augmented reality device (e.g., the augmented reality device 110). The authentication settings (e.g., the particular subset of the user data) may be configured via the mobile device of the user, or via input to the input devices of the premises computing system. In some implementations, the authentication can be performed by transmitting authentication information (e.g., a PIN, biometric data, etc.) to the primary computing system with the authentication settings. In response, the primary computing system can generate a unique token corresponding to the authorization to access and process the subset of the user data.

At step 310 of the method 300, the premises computing system can monitor input from the user via one or more input devices. The input may be monitored at the premises location, for example, in a room that includes the augmented reality device. In some implementations, upon authenticating the user, the room including the augmented reality device can be automatically locked by the premises computing system. The input monitored via the input devices may include speech input, text input (e.g., via a keyboard), or input provided via a mobile device of the user in wireless communication with the premises computing system. In some implementations, the user may provide input to perform additional authentication processes to authorize processing and/or presentation of additional subsets of user data. The various authentication processes may include requesting a PIN from a user, biometric authentication, two-factor authentication via the mobile device of the user, or touchless authentication via the mobile device of the user.

At step 315 of the method 300, the premises computing system can transmit the monitored user input to the generative artificial intelligence system in a request for one or more responses based on the user data stored at the primary computing system. The request may include the authentication settings, or a token generated by the primary computing system that indicates the subset of the user data that is authorized for processing and presentation. Upon receiving the request, the generative artificial intelligence system can generate responses, which may be human-readable text responses produced via one or more generative models (e.g., the generative models 116). In some implementations, the generative models may be executed using the monitored user input to produce the responses.

In some implementations, the generative models may produce commands or requests to access one or more data records corresponding to the user stored at the primary computing system, such as information personal information (e.g., a name, address, any information stored in the user data 126, etc.) or account information (e.g., account balances, assets, any information in the account data 128, etc.). To access the information at the primary computing system, the generative artificial intelligence system may transmit one or more requests to the primary computing system using the authentication settings or the token to access the corresponding user data (e.g., the subset of the user data 126 or account data 128 authorized by the authentication settings). The primary computing system can verify that the token is authentic (e.g., not expired, etc.) and provide the requested user data (if authorized by the authentication settings or token) to the generative artificial intelligence system. Once received, the generative models may utilize the user data to generate one or more responses or outputs as described herein. The responses or outputs may include, for example, data that may be utilized to generate visualizations for display at the augmented reality device, or instructions or templates for generating said visualizations.

At step 315 of the method 300, the premises computing system can present one or more visualizations generated based on the responses received from the generative artificial intelligence system. To do so, the premises computing system can utilize one or more templates or presentation formats, which may be provided in the response received from the generative artificial intelligence system. The premises computing system can present the visualizations at the augmented reality device, which may include several large display devices in a room, as described in connection with FIG. 1B.

As described herein, the premises computing system can communicate with one or more remote computing systems to enable include additional remote users (e.g., affiliated with a financial institution, affiliated with the user, etc.) to communicate with the user at the premises. The remote users may be authenticated using techniques similar to those described herein prior to enabling any information processed by the premises computing system to be shared with the remote computing systems. In some implementations, the remote users may provide their own respective authentication settings, enabling additional information for the remote users stored at the primary computing system to be presented via the augmented reality device or provided to the generative artificial intelligence system for processing. The authentication settings of the user at the premises may authorize the premises computing system to share some or all of the user data presented via the augmented reality device with the remote computing systems.

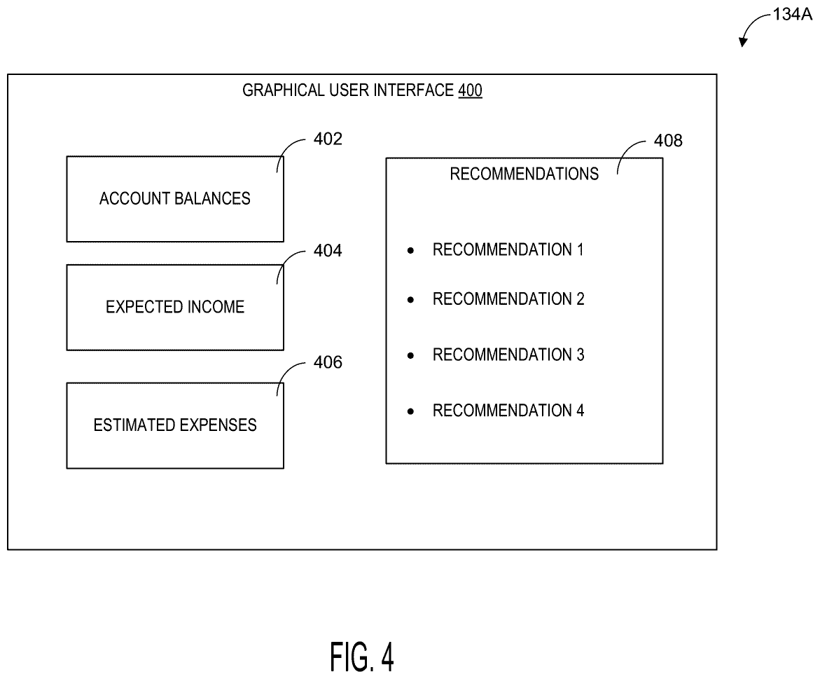

Referring to FIG. 4, illustrated an example graphical user interface 400 that may be displayed via a display device (e.g., the display device 134A) of the augmented reality device 110 described in connection with FIGS. 1A and 1B. As shown, the graphical user interface 400 includes the visualizations 402, 404, 406, which provide the user with a representation of their account balances, expected income, and estimated expenses, respectively, over a predetermined time period. The time period may be provided, for example, in response to a request for a plan to save for an expense, such as a down payment on a mortgage or other loan, a purchase, or a service, among potential expenses. Based on the goal requested by the user, the graphical user interface 400 can present the visualization 408, which may include a list of recommendations to achieve the requested goal within the predetermined time period. The recommendations may be generated by the generative artificial intelligence system 102, as described herein.

The implementations described herein have been described with reference to drawings. The drawings illustrate certain details of specific implementations that implement the systems, methods, and programs described herein. However, describing the implementations with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more general-purpose processors, ASICs, FPGAs, digital signal processors (DSPs), or other suitable electronic data processing components structured to execute instructions provided by memory. The one or more processors may take the form of a single core processor, multi-core processor (e.g., a dual core processor, triple core processor, and/or quad core processor), microprocessor, etc. In some implementations, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the implementations might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard discs, optical discs, etc. In other implementations, the volatile storage media may take the form of RAM, TRAM, ZRAM, etc. Combinations of the above are also included within the scope of machine-readable media. In this regard, machine-executable instructions comprise, for example, instructions and data, which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions and implementation of the implementations without departing from the scope of the present disclosure as expressed in the appended claims.

What is claimed is:

1. A method, comprising:
authenticating, by a premises computing system at a premises location, a user according to one or more authentication settings provided to the premises computing system, the user associated with user data records stored by a primary computing system in communication with the premises computing system, the authentication settings authorizing presentation and processing of a subset of the user data records;
monitoring, by the premises computing system, user input from the user via an input device of the premises computing system;
transmitting, by the premises computing system to a generative artificial intelligence system, a request to generate a response based on the user input, the request regarding the subset of the user data records; and
presenting, by the premises computing system via an augmented reality device, at least one visualization generated based on the response received from the generative artificial intelligence system.

2. The method of claim 1, further comprising:
authenticating, by the premises computing system, the user further based on a wireless communication from a mobile device of the user.

3. The method of claim 2, wherein the user input comprises audio data, and the method further comprises:
monitoring, by the premises computing system, speech input from the user based on the audio data captured via the input device of the premises computing system, the speech input processed using a text-to-speech model.

4. The method of claim 1, further comprising:
automatically transmitting, by the premises computing system, the request to generate the response responsive to detecting the user input.

5. The method of claim 1, further comprising:
receiving, by the premises computing system, the response from the generative artificial intelligence system, the response comprising at least one template; and
generating, by the premises computing system, the at least one visualization based on the at least one template of the response.

6. The method of claim 1, further comprising:
authenticating, by the premises computing system, a remote user via a remote computing system; and
providing, by the premises computing system, the at least one visualization to the remote computing system responsive to authenticating the remote user.

7. The method of claim 6, wherein the one or more authentication settings for the user authorize a second subset of the user data to be shared with the remote user, and the method further comprises:
determining, by the premises computing system, that the at least one visualization is to be shared with the remote computing system based on the one or more authentication settings; and
providing, by the premises computing system, the at least one visualization to the remote computing system responsive to determining that the at least one visualization is to be shared with the remote computing system.

8. The method of claim 6, further comprising:
providing, by the premises computing system, a video stream to the remote computing system for display with the at least one visualization.

9. The method of claim 1, further comprising:
receiving, by the premises computing system, the response from the generative artificial intelligence system, the response including instructions to retrieve the subset of the user data records from the primary computing system; and
generating, by the premises computing system, the at least one visualization by retrieving the subset of the user data records from the primary computing system according to the instructions.

10. A system, comprising:
a premises computing system comprising one or more processors and non-transitory memory, the premises computing system configured to:
authenticate, at a premises location, a user according to one or more authentication settings provided to the premises computing system, the user associated with user data records stored by a primary computing system in communication with the premises computing system, the authentication settings authorizing presentation and processing of a subset of the user data records;
monitor user input from the user via an input device of the premises computing system;
transmit, to a generative artificial intelligence system, a request to generate a response based on the user input, the request regarding the subset of the user data records; and
present, via an augmented reality device, at least one visualization generated based on the response received from the generative artificial intelligence system.

11. The system of claim 10, wherein the premises computing system is further configured to:
authenticate the user further based on a near-field communication (NFC) signal from a mobile device of the user.

12. The system of claim 11, wherein the user input comprises audio data, and the premises computing system is further configured to:
monitor speech input from the user based on the audio data captured via the input device of the premises computing system, the speech input processed using a text-to-speech model.

13. The system of claim 10, wherein the premises computing system is further configured to:
automatically transmit the request to generate the response responsive to detecting the user input.

14. The system of claim 10, wherein the premises computing system is further configured to:
receive the response from the generative artificial intelligence system, the response comprising at least one template; and
generate the at least one visualization based on the at least one template of the response.

15. The system of claim 10, wherein the premises computing system is further configured to:
authenticate a remote user via a remote computing system; and
provide the at least one visualization to the remote computing system responsive to authenticating the remote user.

16. The system of claim 15, wherein the one or more authentication settings for the user authorize a second subset of the user data to be shared with the remote user, and wherein the premises computing system is further configured to:
determine that the at least one visualization is to be shared with the remote computing system based on the one or more authentication settings; and
provide the at least one visualization to the remote computing system responsive to determining that the at least one visualization is to be shared with the remote computing system.

17. The system of claim 10, wherein the prompt comprises at least one question, and wherein the premises computing system is further configured to:
generate the at least one visualization to include one or more answers to the at least one question.

18. The system of claim 10, wherein the premises computing system is further configured to:
receive the response from the generative artificial intelligence system, the response including instructions to retrieve the subset of the user data records from the primary computing system; and
generate the at least one visualization by retrieving the subset of the user data records from the primary computing system according to the instructions.

19. A non-transitory computer-readable medium with instructions embodied thereon that, when executed by one or more processors of a premises computing system, cause the premises computing system to perform operations comprising:
authenticating, at a premises location, a user according to one or more authentication settings provided to the premises computing system, the user associated with user data records stored by a primary computing system in communication with the premises computing system, the authentication settings authorizing presentation and processing of a subset of the user data records;
monitoring user input from the user via an input device of the premises computing system;
transmitting, to a generative artificial intelligence system, a request to generate a response based on the user input, the request indicating the subset of the user data records; and
presenting, via an augmented reality device, at least one visualization generated based on the response received from the generative artificial intelligence system.

20. The non-transitory computer-readable medium of claim 19, wherein the operations further comprise:
generating the at least one visualization to represent a predicted cash flow using the response.
